(19) United States
(12) Patent Application Publication
(10) Pub. No.: US 2016/0376001 A1
(43) Pub. Date: Dec. 29, 2016

(54) VEHICLE INCLUDING A TETRAHEDRAL BODY OR CHASSIS

(71) Applicant: Robin Felix, San Diego, CA (US)

(72) Inventor: Robin Felix, San Diego, CA (US)

(21) Appl. No.: 14/631,156

(22) Filed: Feb. 25, 2015

Related U.S. Application Data
(60) Provisional application No. 62/006,205, filed on Jun. 1, 2014.

(51) Int. Cl. B64C 39/00; B64G 1/42; B63G 8/08; B64C 11/46; B63G 8/04; B64G 1/40; B64C 1/06

(52) U.S. Cl. CPC B64C 39/00; B64G 1/40; B64G 1/421; B64G 1/425; B64C 1/06; B64C 11/46; B63G 8/04; B63G 8/08

(57) ABSTRACT

A vehicle constructed in the shape of tetrahedral. The vehicle may be an aircraft, a space-craft, a sub-surface vehicle, or an unmanned drone. A tetrahedral body component is one of: a regular tetrahedron, an extended tetrahedron, a foreshortened tetrahedron, a tapered tetrahedron, and a truncated tetrahedron. A means for propulsion is mounted to at least one of the faces of the tetrahedral body component. The means for propulsion may include a turbine engine, a water jet, a gas jet, or electromagnetic propulsion. In another embodiment, the means for propulsion include an engine and a propeller. The engine block is mounted internal to the tetrahedral body component, and is located at the intersection of a tetrahedral shape with a cube shape. The engine block is mounted to the tetrahedral body component by struts perpendicular to the faces of the engine block.

### CROSS REFERENCE TO RELATED APPLICATIONS

This application claims the benefit under 35 U.S.C. §119 from provisional U.S. patent application Ser. No. 62/006,205 entitled “VEHICLE INCLUDING A TETRAHEDRAL BODY OR CHASSIS”, filed Jun. 1, 2014. The entirety of the above-listed provisional application is herein incorporated by reference.

### TECHNICAL FIELD

The described embodiments relate generally to a vehicle. More specifically, a vehicle including a body or chassis component in the shape of a tetrahedron.

### SUMMARY

This paper describes a new and unique design for a vehicle including a body or chassis component in the shape of a tetrahedron. For the purpose of brevity, a vehicle including a body or chassis component in the shape of a tetrahedron may be referred to herein as a “tetrahedral vehicle.” Illustratively, a body or chassis component in the shape of a tetrahedron may exhibit strength and stability in three dimensions. For example, a tetrahedral vehicle design may exhibit improved rigidity, strength, or lightness relative to existing three-dimensional vehicle designs, resulting in greater lift capacity. In various embodiments, a tetrahedral vehicle may incorporate one or more means for propulsion mounted in at least one face of a tetrahedral body or chassis. For the purpose of brevity, all references herein to a tetrahedron or tetrahedral shape may refer to a shape including any one or more characteristics or aspects of: a regular tetrahedron or tetrahedral shape with four equal triangular sides, a truncated tetrahedron or tetrahedral shape, a tapered tetrahedron or tetrahedral shape, an extended tetrahedron or tetrahedral shape, a foreshortened tetrahedron or tetrahedral shape, or any other modified tetrahedron or tetrahedral shape, without limitation.

In one embodiment, a tetrahedral vehicle may include means for propulsion including, but not limited to, one or more engines or propellers mounted in each face of the tetrahedron; control of the vehicle may be achieved by varying or directing the force applied by individual engines or propellers. Illustratively, and for the purpose of brevity, references herein to a propeller or propellers may in various embodiments include any form or combination of rotary propulsion means, without limitation. In another embodiment, one or more faces of a tetrahedral vehicle may be alternately or additionally associated with mechanical or fixed control surfaces or manifolds in order to modulate or redirect force produced by one or more propulsion means.

In one embodiment, control over the position, rotation, and movement of a tetrahedral vehicle may be achieved by varying the magnitude or direction of thrust or other forces directed from one or more faces of the tetrahedron. For example, a tetrahedral vehicle may include propulsion means configured to produce or direct thrust perpendicular to each face of a tetrahedral body. Illustratively, producing or directing force from one or more faces of a tetrahedral vehicle may be useful for various applications requiring a vehicle to remain motionless, including, but not limited to, cargo lift and instrumentation; various embodiments of this design may also enable a superior platform for omnidirectional motion in three dimensions. For the purpose of example, vehicles benefiting from the improved strength, stability, and simplified control of this design may include, but are not limited to, piloted or unpiloted aircraft, subsurface vehicles, and spacecraft.

In a first novel aspect, a vehicle includes a tetrahedral body component and at least one propulsion means mounted to the tetrahedral body component. The tetrahedral body component comprises at least one of a regular tetrahedron, an extended tetrahedron, a foreshortened tetrahedron, a tapered tetrahedron, and a truncated tetrahedron. The vehicle is selected from the group consisting of: an aircraft, a space-craft, a sub-surface vehicle, and a unmanned drone. In one example, the propulsion means include an engine block. The engine block is mounted internal to the tetrahedral body component. In another example, the engine block is mounted to in the center of the tetrahedral body component. The engine block is located at the intersection of a tetrahedral shape with a cube shape. The engine block is mounted to the tetrahedral body component by struts perpendicular to six faces of the engine block associated with the cube shape. The propulsion means are mounted to the engine block perpendicular to four faces of the engine block associated with the tetrahedral shape. The propulsion means comprise at least one propulsion means associated with each face of the tetrahedral body. The propulsion means associated with each face of the tetrahedral body comprise at least one engine and at least one propeller associated with each face of the tetrahedral body. The propulsion means include at least one of a propeller, a turbine-jet engine, a reaction-jet engine, a rocket engine, and electro-magnetic propulsion. In one example, the propulsion means is configured to direct thrust perpendicular to at least one side of the tetrahedral body. In another example, the propulsion means is configured to direct thrust perpendicular to each face of the tetrahedral body. The propulsion means may comprise propellers mounted parallel to each face of the tetrahedral body. Each of the propellers is powered by an associated engine.

In a second novel aspect, an apparatus includes a plurality of tetrahedral body components, an energy source, an energy conversion device, a propulsion device, and a processor. Each tetrahedral body component is connected to another tetrahedral body component, wherein the tetrahedral body component comprises at least one of a regular tetrahedron, an extended tetrahedron, a foreshortened tetrahedron, a tapered tetrahedron, and a truncated tetrahedron. The energy conversion device converts energy stored in the energy storage device from potential energy to kinetic energy. The propulsion device directs the kinetic energy. The processor is mounted to the apparatus and controls the operation of the energy conversion device and the propulsion device. The energy storage device is selected from the group consisting of: a chemical energy storage device, an electrochemical energy storage device, an electrical energy storage device, and a thermal energy device. The energy conversion device is selected from the group consisting of: a turbine engine, an electric motor, and a reactor. The propulsion device is selected from the group consisting of: a single propeller, a coaxial propeller, a water jet, a gas jet, a rocket, and an electromagnetic device.

Further details and embodiments and methods and techniques are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1A is a part of a larger FIG. 1, where FIG. 1 is a geometric diagram depicting an illustrative embodiment of a tetrahedral shape.

FIG. 1B is a part of the larger FIG. 1.

FIG. 1C is a part of the larger FIG. 1.

FIG. 1D is a part of the larger FIG. 1.

FIG. 2A is a part of a larger FIG. 2, where FIG. 2 is a schematic diagram depicting an illustrative embodiment of a tetrahedral vehicle including propellers.

FIG. 2B is a part of the larger FIG. 2.

FIG. 2C is a part of the larger FIG. 2.

FIG. 2D is a part of the larger FIG. 2.

FIG. 3A is a part of a larger FIG. 3, where FIG. 3 is a geometric diagram depicting an illustrative embodiment of an engine block shape for an illustrative tetrahedral vehicle.

FIG. 3B is a part of the larger FIG. 3.

FIG. 3C is a part of the larger FIG. 3.

FIG. 3D is a part of the larger FIG. 3.

FIG. 4 is a diagram depicting an illustrative embodiment of an engine block design including engine and strut mounts.

FIG. 5A is a part of a larger FIG. 5, where FIG. 5 is a schematic diagram depicting an illustrative embodiment of a tetrahedral vehicle including engine and strut mounts.

FIG. 5B is a part of the larger FIG. 5.

FIG. 5C is a part of the larger FIG. 5.

FIG. 5D is a part of the larger FIG. 5.

FIG. 6A is a part of a larger FIG. 6, where FIG. 6 is a force diagram depicting thrust produced by an illustrative embodiment of a tetrahedral vehicle.

FIG. 6B is a part of the larger FIG. 6.

FIG. 6C is a part of the larger FIG. 6.

FIG. 6D is a part of the larger FIG. 6.

FIG. 7A is a part of a larger FIG. 7, where FIG. 7 is a force diagram depicting torque produced by an illustrative embodiment of a tetrahedral vehicle.

FIG. 7B is a part of the larger FIG. 7.

FIG. 7C is a part of the larger FIG. 7.

FIG. 7D is a part of the larger FIG. 7.

### DETAILED DESCRIPTION

Reference will now be made in detail to background examples and some embodiments of the invention, examples of which are illustrated in the accompanying drawings.

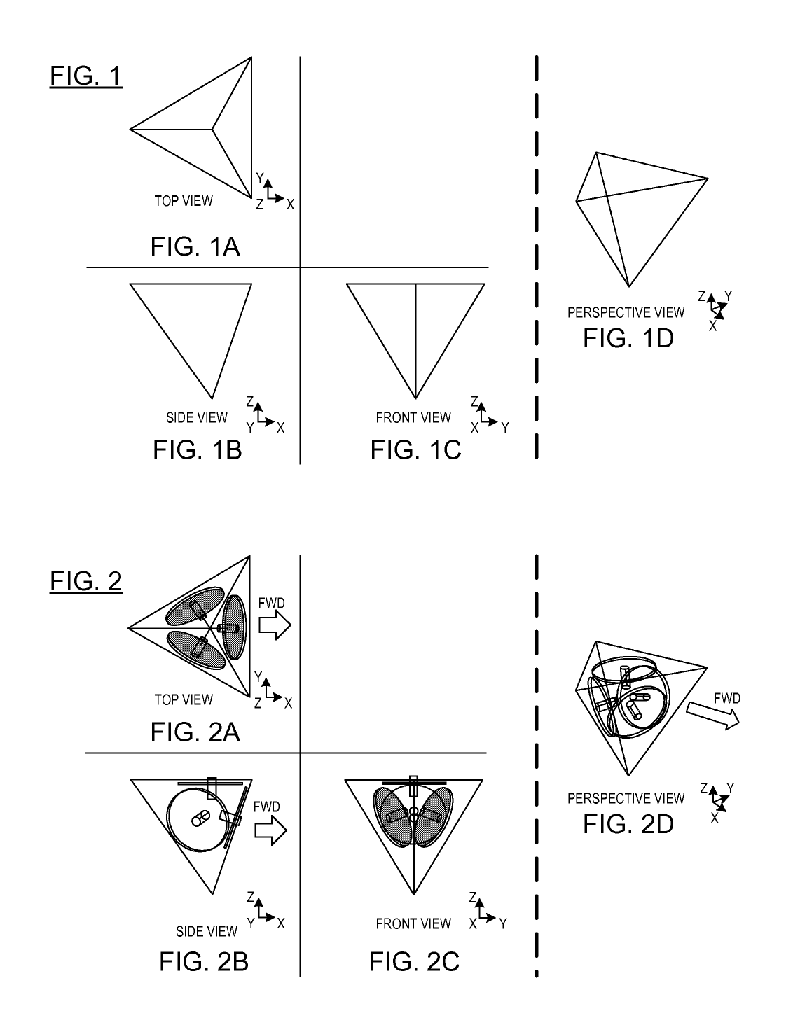

FIG. 1 is a geometric diagram depicting an illustrative embodiment of a tetrahedral shape (“tetrahedron”). From a design perspective, a tetrahedron is stable and provides great strength with very little weight respective to materials used in its construction. Specifically, and for the purpose of example, FIG. 1 shows a regular tetrahedral shape with edges of equal length oriented with one face horizontal at the top. This specific orientation is used for the purpose of example only; various vehicular designs based on a tetrahedral body or chassis may be designed to function in any one or more fixed or variable orientations. In various embodiments, any or all faces may contribute to thrust, and any directional orientation may be possible. In further embodiments, a tetrahedral shape may be truncated, tapered, extended, or otherwise modified. For example, three edges of a tetrahedral shape meeting at a single vertex may be lengthened or shortened to change the shape or properties of three adjoining sides of the shape respective to the fourth side. As a further example, one or more vertexes of a tetrahedral shape may be truncated, thereby creating one or more additional triangular surfaces.

For the purpose of example, a tetrahedral vehicle comprising an illustrative aircraft shall be described herein (“the Illustrative Aircraft”). This Illustrative Aircraft is described herein for the purposes of explanation and example only; specific features and elements described with respect to the Illustrative Aircraft may or may not be included in other embodiments of a tetrahedral vehicle. FIG. 2 depicts an embodiment of the Illustrative Aircraft including propellers mounted respective to a horizontal top face and angled bottom faces. The Illustrative Aircraft may further include a front face pointing forward and strut extensions below the tetrahedral body forming landing gear. In one embodiment, the Illustrative Aircraft may be suitable for use as an unmanned drone aircraft.

In one embodiment, a tetrahedral vehicle may be equally efficient at moving in any horizontal direction. For example, the tetrahedral body of the Illustrative Aircraft may allow for operation in any orientation or direction. In a further embodiment, designating a face of a tetrahedron as the front of a tetrahedral vehicle may allow installation of forward-facing instrumentation or a camera with an unobstructed view. In another embodiment, orienting a vertex at the front end of a tetrahedral vehicle with a face at the rear may provide better drag characteristics in dense mediums such as water (e.g. in the context of an underwater vehicle).

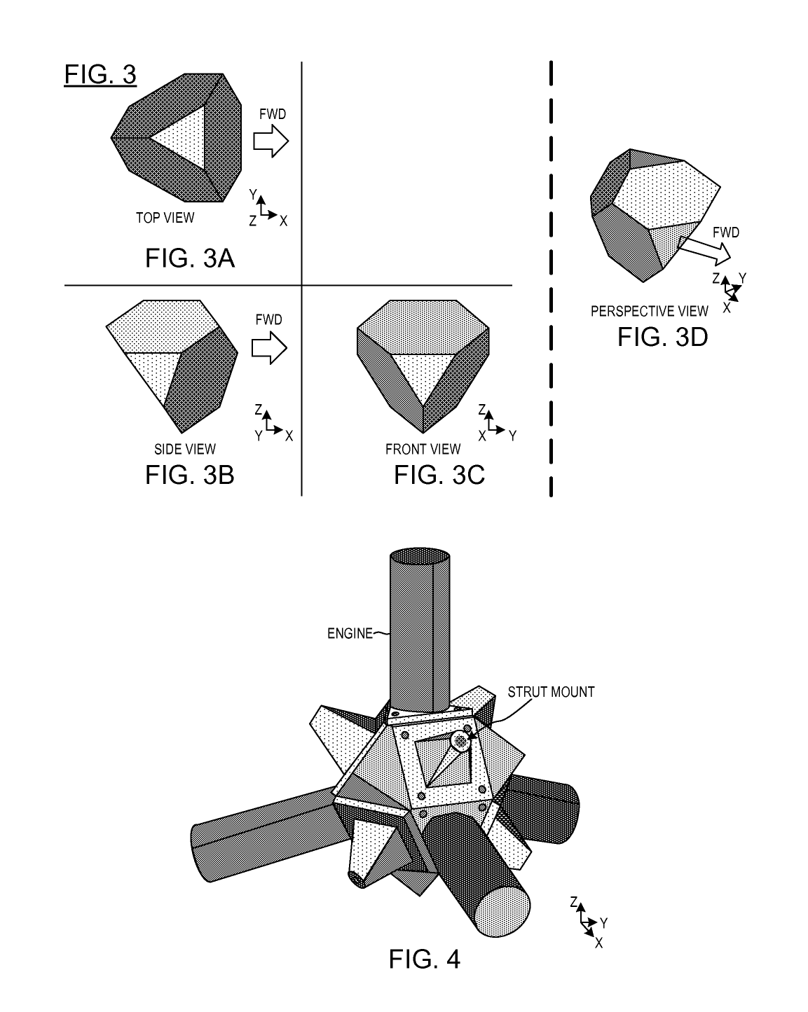

FIG. 3 depicts an illustrative embodiment of an engine block shape for an illustrative tetrahedral vehicle. As shown in illustrative FIG. 3, a shape formed by merging a tetrahedron with a cube creates six faces which may be aligned with the six edges of a tetrahedron and four faces which may be aligned parallel to the four faces of a tetrahedron. In one embodiment, the engine block shape discussed with respect to illustrative FIG. 3 may be centrally mounted in the body of a tetrahedral vehicle.

FIG. 4 depicts an embodiment of the illustrative engine block design shown in FIG. 3 including engine and strut mounts. In the context of our Illustrative Aircraft, the six faces of the engine block depicted in FIG. 4 may be aligned with the edges of the tetrahedral body and utilized for mounting support struts; the four faces perpendicular to the tetrahedron's faces may be used to mount engines. In another embodiment, one or more engines may additionally or alternately be mounted respective to the faces of a tetrahedral vehicle using supports fixed to the edges of the tetrahedron. The shaded cylinders in FIG. 4 represent engines mounted on four faces of the engine block.

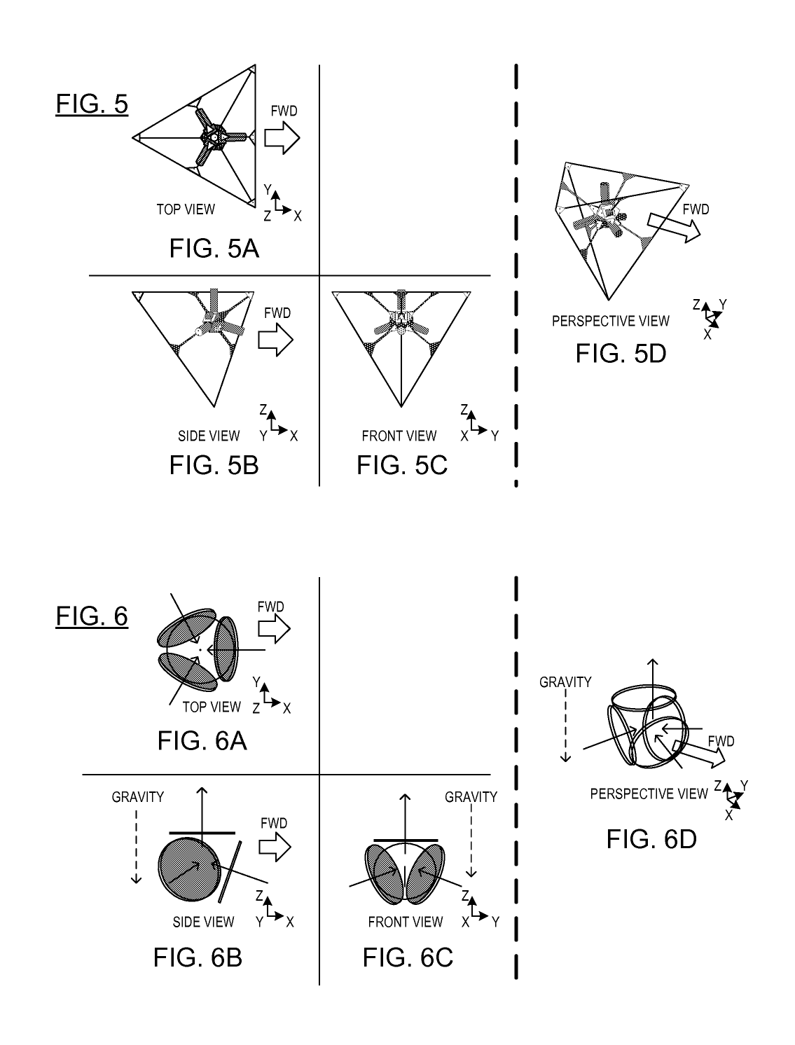

FIG. 5 depicts an illustrative embodiment of a tetrahedral vehicle including engine and strut mounts. For example, and in the context of our Illustrative Aircraft, an engine block such as described with respect to illustrative FIGS. 3 and 4 may be centrally mounted within a tetrahedral body. In the context of this example, struts mounted on each face of an engine block perpendicular to an outer tetrahedral edge may hold the engine block in place and provide structural strength. Illustratively, one or more engines may be mounted on each face of an engine block perpendicular to an outer tetrahedral face.

Still further, and with continued reference to our Illustrative Aircraft, propulsion means such as propellers may be mechanically interfaced with one or more engines mounted on each engine block to produce thrust perpendicular to the faces of the tetrahedral body. In various alternate embodiments, a single engine or any other number of engines may provide power or motive force to one or more propellers.

FIG. 6 is a force diagram depicting thrust produced by an illustrative embodiment of a tetrahedral vehicle. Specifically, and in the context of our Illustrative Aircraft, engines may be controlled to produce various configurations of thrust respective to propellers oriented parallel with the four faces of the Illustrative Aircraft. With respect to our Illustrative Aircraft, and for the purpose of example, we may assume a single engine and propeller mounted respective to each of the four faces of the tetrahedral body. Illustratively, in one configuration of our Illustrative Aircraft the combined thrust of the vertical top engine and the three lower angled engines may exactly counteract the force of gravity, causing the Illustrative Aircraft to remain motionless in the air. In the context of this example, the vertical top engine may produce no force in the x-y plane, while the three lower engines may produce balanced forces that produce no acceleration in the x-y plane. In the context of this example, to move in a desired direction the engine speed for the lower rear engines may be increased, increasing force and creating acceleration in the desired direction; illustratively, this change in engine speed may also create a force in the z direction. In one embodiment, the forward lower and vertical top engine may be reduced in speed to compensate.

In the context of the Illustrative Aircraft discussed above, it may be useful to orient the tetrahedron as depicted in illustrative FIG. 2, with a horizontal top face, a front face pointing forward, and with strut extensions below the tetrahedron forming landing gear. Illustratively, this embodiment may be suitable for use in an unmanned drone aircraft.

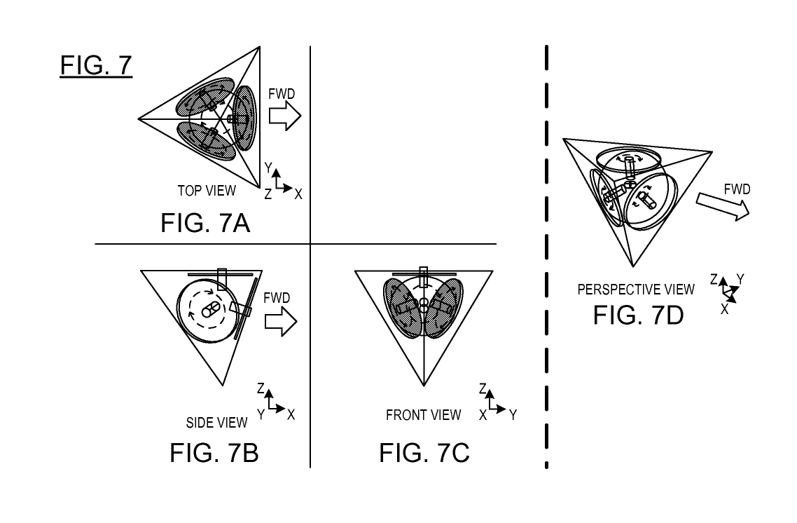

FIG. 7 depicts torque produced by an illustrative embodiment of a tetrahedral vehicle. Illustratively, utilizing rotational propulsion means such as propellers may introduce rotational torque to a vehicle; effectively balancing this torque may increase a vehicle's stability and utility. In the context of our Illustrative Aircraft, and as shown in illustrative FIG. 7, we may assume four propellers, one propeller mounted parallel to each face of the tetrahedral body. In the context of this illustrative design, and to balance rotational torque produced by each of these four propellers, the four propellers may be configured to rotate in the same direction as shown in FIG. 7. With regards to this Illustrative Aircraft, the torsional force of the engine in the upper face may be counterbalanced by the counter-rotational force of the three other engines, with each diagonal engine contributing one-third of the torque contributed by the engine in the upper face. Specifically, and in the context of the Illustrative Aircraft, spinning all four engines at the same speed may produce symmetric rotational torque across all faces of the tetrahedral body. In other embodiments, torque may be controlled or mitigated by mounting two or more engines or propellers respective to the same face of the tetrahedral body and cancelling torque using coaxial or counter-rotation.

In a general case, a tetrahedral vehicle may be concerned with stability values of yaw, turning of the vehicle around its central z-axis; pitch, tipping of the vehicle around its y-axis; or roll, turning of the vehicle around its x-axis. As an example, if our Illustrative Aircraft is motionless relative to the ground at some altitude, its yaw, pitch, and roll must all be zero. To move in a particular direction while maintaining stability, a force may be applied in the desired direction in order to produce acceleration while maintaining a balance of torsional forces to prevent yaw, pitch, and roll.

In the context of our Illustrative Aircraft, propulsion means driven by the engines may allow for the controlled application of force or torque by the four engines. In one embodiment, modulation of thrust or balancing of torque may be performed in real-time in response to a desired vehicle motion or position and measurements of acceleration, rotation, and velocity in the x, y, and z planes.

In one embodiment, one or more computing devices associated with an illustrative tetrahedral vehicle may modulate thrust or torque associated with the vehicle. Illustratively, computing devices associated with an illustrative vehicle may be incorporated into the design of the vehicle, or may remotely control or direct various vehicle functionalities through any number of wired or wireless communication technologies as known in the art. In various other embodiments, any number of alternate or additional computational or mechanical control systems as known in the art may be utilized. Illustratively, various computational or mechanical control systems may utilize sensor inputs from any number of remote or local sensor devices such as accelerometers, barometers, GPS sensors, or other sensors.

For example, engine control may be implemented through one or more control algorithms including, but not limited to, the mathematical technique of proportional-integral-derivative, or PID control. In the context of this example, given a setpoint (e.g. a target value for a stability attribute such as yaw, pitch, and roll, or a movement attribute such as position or acceleration), PID control may measure the difference between the setpoint and a measured value and adjust outputs (e.g. engine speed) to achieve the setpoint.

PID control or other control systems may be utilized with regards to any number of different embodiments or configurations of a tetrahedral vehicle. For example, control systems may be implemented or function in a similar manner regardless of a medium in which a vehicle is moving: whether in an atmosphere constrained by gravity, underwater constrained by buoyancy, in space with very few external force constraints, or in any other medium.

Illustratively, efficient orientation and design of a tetrahedral vehicle may vary based on performance and efficiency considerations and a medium through which it is traveling. For example, a physical mounting of an engine or direction of engine thrust may be modified depending on the requirements of a mission or intended use. As another example, a tetrahedral body shape may be elongated, tapered, or foreshortened (e.g. by changing the shape of triangles forming the faces of the tetrahedron), or may include one or more truncated vertex in order to provide various stability, efficiency, or maneuverability characteristics. Various components or body sections of a tetrahedral vehicle may incorporate any material known in the art, including, but not limited to, carbon fiber, aluminum, steel, wood, graphite, plastic, etc. In one embodiment, a body of a tetrahedral vehicle may be 3-D printed or otherwise manufactured as a single structural component. In another embodiment, a body of a tetrahedral vehicle may combine a number of separable or moveable structural elements. For example, in one embodiment a tetrahedral vehicle body may be easily disassembled or include folding means.

In various embodiments, thrust and torque may be produced by rotary propulsion means such as propellers or certain types of turbine engines. In other embodiments, any number of propulsion methods may be utilized that produce only thrust, including, but not limited to certain alternate types of turbine engines, water jets, gas jets, rockets, electromagnetic propulsion, co-axial or torque balancing propellers, etc. In various embodiments, a tetrahedral vehicle may include additional or alternate control mechanisms to control roll, pitch, yaw, or direction of thrust including, but not limited to, additional or alternate torque-producing means (e.g. flywheels or propellers), additional propulsion means (e.g. jets or other devices mounted on or near edges or vertices of the tetrahedral body), actuation means associated with one or more engine or propulsion means (e.g. engine or propulsion mountings allowing changes in the angle of thrust respective to the face of the tetrahedron), control surfaces to modulate or direct thrust, or any other control means as known in the art. For example and with respect to our Illustrative Aircraft, various of the propellers shown in illustrative FIG. 7 may be actuated to rotate slightly on one or more axis respective to their associated face. As another example, one or more faces of our Illustrative Aircraft may include control surfaces or manifolds in addition to or as an alternative to a propeller or engine.

It should be emphasized that many variations and modifications may be made to the herein described embodiments; all aspects and elements of said variations and modifications among other acceptable examples are to be understood as being described herein. Specifically, conditional language, including, but not limited to, “can,” “could,” “might,” or “may,” unless stated otherwise, is generally intended to convey that certain embodiments include certain features, elements or steps, while other embodiments may contain additional, fewer, alternate, or modified features, elements, or steps. Such conditional language is not generally intended to imply that features, elements or steps are in any way required in the context of one or more embodiments, or that embodiments include logic for deciding, with or without user input or prompting, whether particular features, elements or steps are included or are to be performed in any particular embodiment. Alternative conjunctions such as “or,” unless stated otherwise, are generally intended as inclusive, and should be interpreted as including any possible combination of one or more features, elements, or steps.

What is claimed is:

1. A vehicle, comprising:
a tetrahedral body component; and
at least one propulsion means mounted to the tetrahedral body component.

2. The vehicle of claim 1, wherein the tetrahedral body component comprises at least one of a regular tetrahedron, an extended tetrahedron, a foreshortened tetrahedron, a tapered tetrahedron, and a truncated tetrahedron.

3. The vehicle of claim 1, wherein the vehicle is selected from the group consisting of:
an aircraft, a space-craft, a sub-surface vehicle, and an unmanned drone.

4. The vehicle of claim 1, wherein the propulsion means mounted to the tetrahedral body component includes an engine block mounted to the tetrahedral body.

5. The vehicle of claim 4, wherein the engine block is mounted internal to the tetrahedral body component.

6. The vehicle of claim 4, wherein the engine block is mounted in the center of the tetrahedral body component.

7. The vehicle of claim 4, wherein the engine block is formed in the shape of a tetrahedral shape intersected with a cube shape.

8. The vehicle of claim 7, wherein the engine block is mounted to the tetrahedral body component by struts perpendicular to six faces of the engine block associated with the cube shape.

9. The vehicle of claim 8, wherein the propulsion means are mounted to the engine block perpendicular to four faces of the engine block associated with the tetrahedral shape.

10. The vehicle of claim 9, wherein the propulsion means comprise at least one propulsion means associated with each face of the tetrahedral body.

11. The vehicle of claim 10, wherein the propulsion means associated with each face of the tetrahedral body comprise at least one engine and at least one propeller associated with each face of the tetrahedral body.

12. The vehicle of claim 11, wherein the at least one propeller comprises a plurality of co-axial propellers, and wherein the plurality of co-axial propellers include counter-rotating propellers.

13. The vehicle of claim 1, wherein the propulsion means include at least one of a propeller, a turbine-jet engine, a reaction-jet engine, a rocket engine, and electro-magnetic propulsion.

14. The vehicle of claim 1, wherein the propulsion means is configured to direct thrust perpendicular to at least one side of the tetrahedral body.

15. The vehicle of claim 1, wherein the propulsion means is configured to direct thrust perpendicular to each face of the tetrahedral body.

16. The vehicle of claim 15, wherein the propulsion means comprises propellers mounted parallel to each face of the tetrahedral body, and wherein each of the propellers is powered by an associated engine.

17. An apparatus, comprising:
a tetrahedral body component that is selected from a group consisting of: a regular tetrahedron, an extended tetrahedron, a foreshortened tetrahedron, a tapered tetrahedron, and a truncated tetrahedron;
an energy storage device;
an energy conversion device, wherein the energy conversion device converts energy stored in the energy storage device from potential energy to kinetic energy;
a propulsion device, wherein the propulsion device directs the kinetic energy; and
a processor mounted to the apparatus that controls the operation of the energy conversion device and the propulsion device.

18. The apparatus of claim 17, wherein the energy storage device is selected from the group consisting of: a chemical energy storage device, an electrochemical energy storage device, an electrical energy storage device, and a thermal energy device.

19. The apparatus of claim 17, wherein the energy conversion device is selected from the group consisting of: a turbine engine, an electric motor, and a reactor.

20. The apparatus of claim 17, wherein the propulsion device is selected from the group consisting of: a single propeller, a coaxial propeller, a water jet, a gas jet, a rocket, and an electromagnetic device.
